(19) United States
(12) Patent Application Publication
(10) Pub. No.: US 2006/0110560 A1
(43) Pub. Date: May 25, 2006

(54) Coriolis mass flow meter and method for manufacturing a measuring tube for a coriolis mass flow meter

(76) Inventors: Yousif A. Hussain, Northampton (GB); Chris N. Rolph, Northampton (GB); Neil Harrison, Northampton (GB)

Correspondence Address: CESARI AND MCKENNA, LLP, 88 BLACK FALCON AVENUE, BOSTON, MA, 02210, US

(21) Appl. No.: 11/258,666

(22) Filed: Oct. 20, 2005

(30) Foreign Application Priority Data
Nov. 25, 2004 (DE) 10 2004 057 088.4

(51) Int. Cl. F16L 11/04

(52) U.S. Cl. 428/36.91

(57) ABSTRACT

A Coriolis mass flow meter incorporates a measuring tube whose wall is of fiber-reinforced polyether ether ketone (PEEK) and has an internal coating of pure polyether ether ketone (PEEK). The measuring tube is corrosion-resistant and has high pressure resistance. A method of manufacturing the measuring tube is also described.

The present invention relates to a Coriolis mass flow meter, having a measuring tube which may be excited to oscillations, and a method for manufacturing a measuring tube for a Coriolis mass flow meter.

### BACKGROUND OF THE INVENTION

1. Field of the Invention

Coriolis mass flow meters are well known from practice. In this type of mass flow meter, at least one measuring tube is excited to oscillations, so that Coriolis forces may be generated in a medium flowing through the measuring tube. These Coriolis forces and/or deflections of the measuring tube generated therefrom are detected in order to be able to thus conclude the mass flow rate, e.g., via the phase shift of the deflections of the measuring tube at its inlet and/or outlet side. In this regard, a general reference is made to “K. W. Bonfig, Technische Durchfluβmessung [Technical Flow Rate Measurement], 3rd edition, 2002, Vulkan-Verlag GmbH, pp. 215-226”.

2. Description of Prior Art

Measuring tubes for Coriolis mass flow meters are frequently manufactured from metallic materials, such as stainless steel, titanium, tantalum, etc. However, attempts to use non-metallic materials for a measuring tube of a Coriolis mass flow meter are also known. According to DE 41 19 396 C1, for example, the measuring tube of a Coriolis mass flow meter comprises carbon obtained through pyrolysis of non-meltable plastics. Furthermore, a Coriolis mass flow meter having a measuring tube made of ceramic is known from DE 100 37 784 A1. Coriolis mass flow meters having a measuring tube made of a non-metallic material may be advantageous because, among other reasons, they are also usable for flow rate measurement in the presence of chemically aggressive media, i.e., they have a high corrosion resistance.

### SUMMARY OF THE INVENTION

It is the object of the present invention to specify a Coriolis mass flow meter of this type and a method of this type for manufacturing a measuring tube of a Coriolis mass flow meter, by which a mass flow rate measurement of chemically aggressive media is made possible, with optimal adaptation of the parameters of the Coriolis mass flow meter, such as temperature and pressure resistance, to the particular application being made possible at the same time.

On the basis of the Coriolis mass flow meter described at the outset, the object derived and described above is achieved in that the measuring tube is of fiber-reinforced polyether ether ketone and has an inner coating made of pure polyether ether ketone.

The present invention thus provides the combination of polyether ether ketone, also known as PEEK, in fiber-reinforced form with pure PEEK as the inner coating, “pure” in this context meaning that the PEEK is provided as such, i.e., without fiber reinforcement. The term “pure” is not meant in this case to indicate a particular degree of purity so that no fiber reinforcements are to be provided in the pure PEEK, but rather the addition of other material is not excluded. According to a preferred embodiment of the present invention, however, PEEK which is practically free of additives is used as the “pure” PEEK, in order to ensure high corrosion resistance of the inner coating.

In principle, a fiber material of a type which is added to the PEEK without orientation may be used for the fiber-reinforced PEEK. However, according to a preferred embodiment of the present invention, the fibers provided for reinforcement in the PEEK should have at least one predefined orientation. Furthermore, it is preferable in this case for the fibers to run in the lengthwise direction of the measuring tube and/or in a helix shape, preferably in a double helix shape.

In principle, multiple fiber materials are usable for reinforcing the polyether ether ketone. However, according to a preferred embodiment of the present invention, graphite fiber-reinforced polyether ether ketone is used.

In principle, it is possible to use fiber-reinforced polyether ether ketone and/or pure polyether ether ketone only partially for the measuring tube. However, according to a preferred embodiment of the present invention, the wall of the measuring tube is made of fiber-reinforced polyether ether ketone and the inner surface of the wall is completely covered with an internal coating made of pure polyether ether ketone. It is particularly preferred in this case for the wall of the measuring tube to be wound from fiber-reinforced polyether ether ketone strips or layers and/or the internal coating to be wound from pure polyether ether ketone strips or layers.

Furthermore, according to a preferred embodiment of the present invention, the wall of the measuring tube made of fiber-reinforced polyether ether ketone may have a greater wall thickness at certain locations to be reinforced than at other locations. In other words, additional windings and/or layers of the fiber-reinforced polyether ether ketone may be applied to those certain locations during the manufacturing of the wall of the measuring tube.

The transition from the fiber-reinforced polyether ether ketone to the inner coating made of pure polyether ether ketone may be arbitrary in principle. However, according to a preferred embodiment of the present invention, the wall made of fiber-reinforced polyether ether ketone and the internal coating made of pure polyether ether ketone have a bond produced through tempering.

On the basis of the method described at the beginning for manufacturing a measuring tube for a Coriolis mass flow meter, the object derived and described further above is achieved in that at least one strip made of pure polyether ether ketone is wound on a mandrel and at least one layer made of a fiber-reinforced polyether either ketone is wound around the pure polyether ether ketone strip.

In this case, according to a preferred embodiment of the present invention, as already noted above, that layer is of graphite fiber-reinforced polyether ether ketone.

As also already noted above, in principle fiber-reinforced polyether ether ketone of the type in which the fibers used for reinforcement are randomly oriented is usable. However, according to a preferred embodiment of the present invention, fiber-reinforced polyether ether ketone whose fibers provided for reinforcement are oriented in at least one predefined direction is used. According to an especially preferred embodiment, the fiber-reinforced polyether ether ketone is wound up in this case in such a way that the fibers in the windings or turns run in the lengthwise direction of the tube and/or in a helix shape, preferably in a double helix shape. In this way, a measuring tube is obtained which is highly resistant to pressure and has a moderate temperature expansion.

Furthermore, according to a preferred embodiment of the present invention, selected points or locations on the measuring tube to be reinforced may be provided with additional reinforcement windings or layers made of fiber-reinforced polyether ether ketone. These reinforced points or locations of the measuring tube may be used, for example, to attach additional components to the measuring tube and/or to fasten the measuring tube in an external pipeline system.

Furthermore, according to a preferred embodiment of the present invention, the windings or turns of the pure polyether ether ketone which are next to one another may be wound so that they partially overlap one another. In this case, the overlaps may also be bonded to one another by heating, preferably under increased pressure.

In principle, it is not absolutely necessary to treat the external surface of the pure polyether ether ketone strip wound on the mandrel before the fiber-reinforced polyether ether ketone layer or strip is wound around it. However, according to a preferred embodiment of the present invention, the external surface of the pure polyether ether ketone wound on the mandrel is etched before the fiber-reinforced polyether ether ketone is wound around it, preferably by chemical etching.

Furthermore, according to a preferred embodiment of the present invention, the measuring tube having the pure polyether ether ketone with the fiber-reinforced polyether ether ketone wound around it is tempered, i.e., subjected to a heat treatment. In this case, the tempering is preferably performed at a temperature between 80° C. and 120° C., preferably at approximately 100° C. This temperature treatment should be performed for a duration of 3 to 5 hours, preferably for approximately 4 hours. A temperature treatment of this type should be sufficient in principle. However, according to a preferred embodiment of the invention, this treatment is followed by a further tempering at a lower temperature, preferably at a temperature between 50° C. and 80° C., most preferably at a temperature of approximately 60° C. This tempering at the lower temperature is preferably performed for a duration of 3 to 5 hours, and most preferably for approximately 4 hours.

In principle, the shape of the measuring tube achieved through the winding of strips or layers on a mandrel may be used as is for a Coriolis mass flow meter. However, adaptations of the measuring tube, particularly at the points reinforced through additional windings of fiber-reinforced polyether ether ketone, may be derived by mechanically processing the original measuring tube, e.g., through metal cutting methods.

There are now manifold possibilities for specifically designing and refining the Coriolis mass flow meter according to the present invention and the method according to the present invention for manufacturing a measuring tube for a Coriolis mass flow meter. For this purpose, reference should be made to the dependent claims and to the following detailed description of a preferred embodiment of the present invention with reference to the accompanying drawings.

In the drawings:

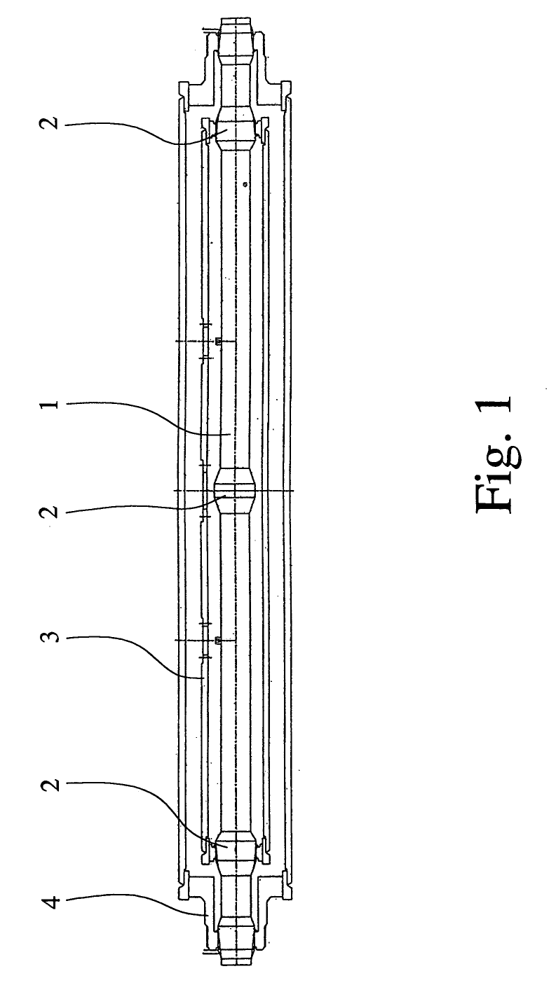

FIG. 1 is a longitudinal sectional view of a Coriolis mass flow meter according to a preferred embodiment of the present invention, and

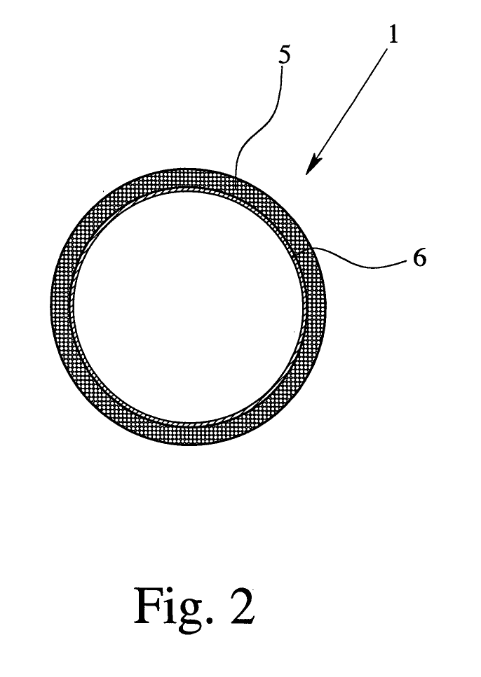

FIG. 2 is a cross-sectional view on a larger scale of the measuring tube of the Coriolis mass flow meter shown in FIG. 1.

### DESCRIPTION OF THE PREFERRED EMBODIMENTS

FIG. 1 shows a Coriolis mass flow meter according to a preferred embodiment of the present invention, whose measuring tube 1 is manufactured as described below.

A mandrel (not shown) having a diameter of 25.4 mm is wound with a film strip made of pure PEEK having a thickness of 0.05 mm with a lateral overlap of 5 mm on each side. The film strips are then bonded to one another at their overlaps by heating them under pressure. The external surface of the pure PEEK wound on the mandrel is then chemically etched, using a chromic acid solution, in order to improve the bonding with a layer made of fiber-reinforced PEEK to be wound on the pure PEEK as will now be described.

After the just-described chemical etching of the external surface of the pure PEEK wound on the mandrel, two layers of graphite-fiber-reinforced PEEK having a thickness of 0.125 mm each are wound onto the pure PEEK. For the graphite-fiber-reinforced PEEK, a material of a type in which the graphite fibers are oriented in a predefined direction is used. In this case, the two layers of the graphite fiber-reinforced PEEK are wound in such a way that the orientation of the graphite fibers corresponds to the lengthwise direction of the measuring tube 1. Subsequently, two additional layers of graphite fiber-reinforced PEEK having a thickness of 0.125 mm each are applied in such a way that the orientations of the graphite fibers in relation to the lengthwise direction of the measuring tube 1 are +82.5° and −82.5°, respectively. Therefore, the graphite fibers in additional layers of the graphite fiber-reinforced PEEK extend substantially in a double helix shape around the measuring tube 1. Depending upon the orientation of the direction of the fibers provided for reinforcing the PEEK, the dynamics, the thermal properties, and the pressure resistance of the measuring tube 1 may be determined. Thus, the wall 5 of the measuring tube 1 has a thickness of 0.5 mm, the internal coating 6 has a thickness of 0.05 mm, so that tube 1 has an overall wall thickness of 0.55 mm.

Further layers of graphite-fiber-reinforced PEEK may be applied at predefined points or locations 2 on the measuring tube 1 to be reinforced, as is shown in FIG. 1. These reinforced points or locations 2 are used for attaching other components of the Coriolis mass flow meter, such as an internal cylinder 3, and/or for fastening the measuring tube 1 in a housing 4 for the Coriolis mass flow meter. As may also be seen from FIG. 1, these points or locations 2 to be reinforced may be additionally mechanically processed or shaped in order to achieve conically extending surfaces.

Subsequently, the measuring tube 1 is preferably tempered, at 100° C. for four hours and subsequently at a lower temperature of 60° C. for a further four hours.

Using this method, a measuring tube 1 for a Coriolis mass flow meter having a length of 620 mm, an internal diameter of 25.4 mm, and an external diameter of approximately 26.4 mm is achieved. The tube has a construction as is shown in FIG. 2, which figure is a section through the measuring tube 1 outside a reinforced point 2. Through the tempering process, a bonding of both the internal coating 6 to the wall 5 and of the individual layers made of fiber-reinforced PEEK in the wall 5 itself has occurred. A test measurement using water flowing through the measuring tube 1 finally results in a natural frequency for the first mode of the measuring tube 1 at approximately 192 Hz, so that the measuring tube manufactured in this way is quite suitable for use in a Coriolis mass flow meter.

What is claimed is:

1. A Coriolis mass flow meter, having a measuring tube which may be excited to oscillations, wherein the measuring tube comprises fiber-reinforced polyether ether ketone having an internal coating of pure polyether ether ketone.

2. The Coriolis mass flow meter according to claim 1, wherein the fibers in the fiber-reinforced polyether ether ketone have at least one predefined orientation.

3. The Coriolis mass flow meter according to claim 2, wherein said fibers extend in the lengthwise direction of the measuring tube and/or in a helix shape, preferably in a double helix shape.

4. The Coriolis mass flow meter according to any one of claims 1 through 3, wherein the fiber-reinforced polyether ether ketone comprises graphite fiber-reinforced polyether ether ketone.

5. The Coriolis mass flow meter according to any one of claims 1 through 3, wherein the measuring tube has a wall made of said fiber-reinforced polyether ether ketone and the internal surface of the wall is completely covered with said internal coating made of pure polyether ether ketone.

6. The Coriolis mass flow meter according to claim 5, wherein said wall is wound from fiber-reinforced polyether ether ketone strips and/or the internal coating is wound from pure polyether ether ketone strips.

7. The Coriolis mass flow meter according to claim 5, wherein said wall has a greater wall thickness at selected locations to be reinforced than at other locations.

8. The Coriolis mass flow meter according to claim 5, wherein said wall and said internal coating have a bond produced through tempering.

9. A method for manufacturing a measuring tube for a Coriolis mass flow meter, said method comprising the steps of winding at least one strip of pure polyether ether ketone on a mandrel and winding at least one layer of fiber-reinforced polyether ether ketone around said strip.

10. The method according to claim 9, wherein said at least one layer is of graphite fiber-reinforced polyether ether ketone.

11. The method according to claim 9 or 10, wherein the fibers of said fiber-reinforced polyether ether ketone are oriented in at least one predefined direction.

12. The method according to claim 11, wherein said fibers are oriented in the lengthwise direction of the measuring tube and/or in a helix shape, preferably in a double helix shape.

13. The method according to claim 9 or 10, including the step of providing additional reinforcement layers of fiber-reinforced polyether ether ketone at selected locations on the measuring tube.

14. The method according to claim 9 or 10, including the step of winding said at least one strip so that adjacent windings thereof partially overlap one another.

15. The method according to claim 14, including the step of bonding the winding overlaps through heating, preferably under elevated pressure.

16. The method according to claim 9 or 10, including the step of etching an outer surface of said strip wound on the mandrel, preferably by chemically etching, before said layer is wound around the strip.

17. The method according to claim 9 or 10, including the step of tempering the measuring tube.

18. The method according to claim 17, wherein the tempering is performed at a temperature between 80° C. and 120° C., preferably at 100° C.

19. The method according to claim 18, wherein the tempering is performed for a duration of 3 to 5 hours, preferably for 4 hours.

20. The method according to claim 18, wherein the tempering at the temperature between 80° C. and 120° C. is followed by further tempering at a lower temperature, between 50° C. and 80° C. preferably at 60° C.

21. The method according to claim 20, wherein the further tempering at the lower temperature is performed for a duration of 3 to 5 hours, preferably for 4 hours.
